(19) United States
(12) Patent Application Publication
(10) Pub. No.: US 2009/0076898 A1
(43) Pub. Date: Mar. 19, 2009

(54) System And Method For Delivering Offline Advertisement Supported Digital Content

(76) Inventors: Yiqing Wang, Bothell, WA (US); Adam Fritz, Seattle, WA (US); Christopher Allen White, JR., Redmond, WA (US); Dionysius C. Mavromatis, Kirkland, WA (US)

Correspondence Address: DISNEY ENTERPRISES, INC;C/O SMITH FROHWEIN TEMPEL GREENLEE BLAHA LLC, TWO RAVINIA DRIVE, SUITE 700, ATLANTA, GA, 30346, US

(21) Appl. No.: 11/855,201

(22) Filed: Sep. 14, 2007

(51) Int. Cl. G06Q 30/00

(52) U.S. Cl. 705/14

(57) ABSTRACT

A system for receiving advertisement supported content in a media device, including a media collector for receiving primary content and secondary content in a media device, the primary content comprising a media asset and the secondary content comprising an advertisement, a file system for organizing the primary content and the secondary content, and a player for playing the primary content and inserting the secondary content into the primary content at a time determined by the file system.

### BACKGROUND

The delivery of rich media assets to communication devices capable of playing the media asset continues to increase. The term rich media asset includes, but is not limited to, video programming, games, sporting events, interactive features etc. Currently there are two primary models for the delivery of rich media assets. These are the purchase-to-own model and the ad-supported streaming model. The purchase-to-own model requires a user to download a protected file containing the media content after finishing the required purchase steps. The pricing structure for the purchase-to-own model dictates that the price of the media asset is the primary source of revenue. The costs of establishing and maintaining a media catalog and a commerce server, and providing customer support is a constant. A site has to have a certain number of purchase transactions to cover the operational cost. The profit is limited by the number of users and the download market. Further, the industry has not found an effective digital rights management (DRM) method to ensure that the media asset is correctly protected.

The ad-supported streaming model allows a user to view streaming content on a player. The pricing structure for the ad-supported streaming model dictates that ad revenue income is the major revenue. The cost of delivery is linear to the amount of data delivered. Profit constraints include the number of concurrent users supported by the streaming server, and the amount of client side bandwidth available.

In addition, using broadcast television as an example, commercials are targeted by the demographic of the households that watch the show, with one commercial per slot. Because viewer information can only be estimated, this results in a “shotgun” approach to targeting advertising.

Therefore, there is a need for another way of delivering advertisement supported rich media assets to a user, monitoring the users interaction with the advertisement and targeting the advertisement to a user.

### SUMMARY

Embodiments of the invention include a system for receiving advertisement supported content in a media device, including a media collector for receiving primary content and secondary content in a media device, the primary content comprising a media asset and the secondary content comprising an advertisement, a file system for organizing the primary content and the secondary content, and a player for playing the primary content and inserting the secondary content into the primary content at a desired time, such as at a time determined by the file system.

Other embodiments are also provided. Other systems, methods, features, and advantages of the invention will be or become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE FIGURES

The invention can be better understood with reference to the following figures. The components within the figures are not necessarily to scale, emphasis instead being placed upon clearly illustrating the principles of the invention. Moreover, in the figures, like reference numerals designate corresponding parts throughout the different views.

FIG. 1 is a block diagram illustrating an example of an off-line ad supported rich media asset system.

FIG. 2 is a block diagram illustrating an embodiment of the advertisement management system of FIG. 1.

FIG. 3 is a schematic diagram illustrating an embodiment of the service manager of FIG. 1.

FIG. 4 is a block diagram illustrating an embodiment of the tracking system of FIG. 1.

FIG. 5 is a block diagram illustrating a simplified media device in accordance with an embodiment of the system and method for delivering offline ad supported digital content.

FIG. 6 is a flow chart describing the operation of an embodiment of the media device of FIG. 5.

FIG. 7 is a flowchart describing the operation of an embodiment of the content management system and the advertisement management system of FIG. 1.

FIG. 8 is a flowchart describing the operation of an alternative embodiment of the media device of FIG. 5.

FIG. 9 is a flow chart describing the operation of another alternative embodiment of the media device of FIG. 5.

FIG. 10A is a schematic diagram illustrating an embodiment of a simplified program stream.

FIG. 10B is a schematic diagram illustrating an alternative embodiment of a simplified program stream.

FIG. 11 is a flow chart describing the operation of another alternative embodiment of the media device of FIG. 5.

FIG. 12 is a flow chart describing the operation of another alternative embodiment of the media device of FIG. 5.

### DETAILED DESCRIPTION

The system and method for delivering offline advertisement supported digital content will be described in the context of delivering rich media assets, such as video, audio, programming, games, sporting events, interactive programming and features, such as, for example, interactive advertisements, etc. However, the system and method for delivering offline advertisement supported digital content can be used to provide any media asset to a user. Further, the system and method for delivering offline advertisement supported digital content can deliver targeted advertisements to a viewer, or can store a variety of advertisements on a media device, and display a particular advertisement to a viewer based on a viewer profile or on viewer preferences. Further, the system and method for delivering offline advertisement supported digital content can provide to a user a variety of assets and/or advertisements via a portable removable memory element. An example of a portable removable memory element can be a flash memory card or device, such as a secure digital (SD) memory card, a flash memory drive, or any other portable memory device. Such a portable memory device can be inserted, or otherwise associated with a media device.

The system and method for delivering offline advertisement supported digital content can be implemented in hardware, software, or a combination of hardware and software. When implemented in hardware, the system and method for delivering offline advertisement supported digital content can be implemented using specialized hardware elements and logic. When the system and method for delivering offline advertisement supported digital content is implemented in software, the software can be used to control the various components in a system and network associated with the program. The software can be stored in a memory and executed by a suitable instruction execution system (microprocessor). The hardware implementation of the system and method providing additional content to a program stream can include any or a combination of the following technologies, which are all well known in the art: discrete electronic components, a discrete logic circuit(s) having logic gates for implementing logic functions upon data signals, an application specific integrated circuit having appropriate logic gates, a programmable gate array(s) (PGA), a field programmable gate array (FPGA), etc.

The software for the system and method for delivering offline advertisement supported digital content comprises an ordered listing of executable instructions for implementing logical functions, and can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM), a read-only memory (ROM), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance, optical scanning of the paper or other medium, then compiled, interpreted or otherwise processed in a suitable manner if necessary, and then stored in a computer memory.

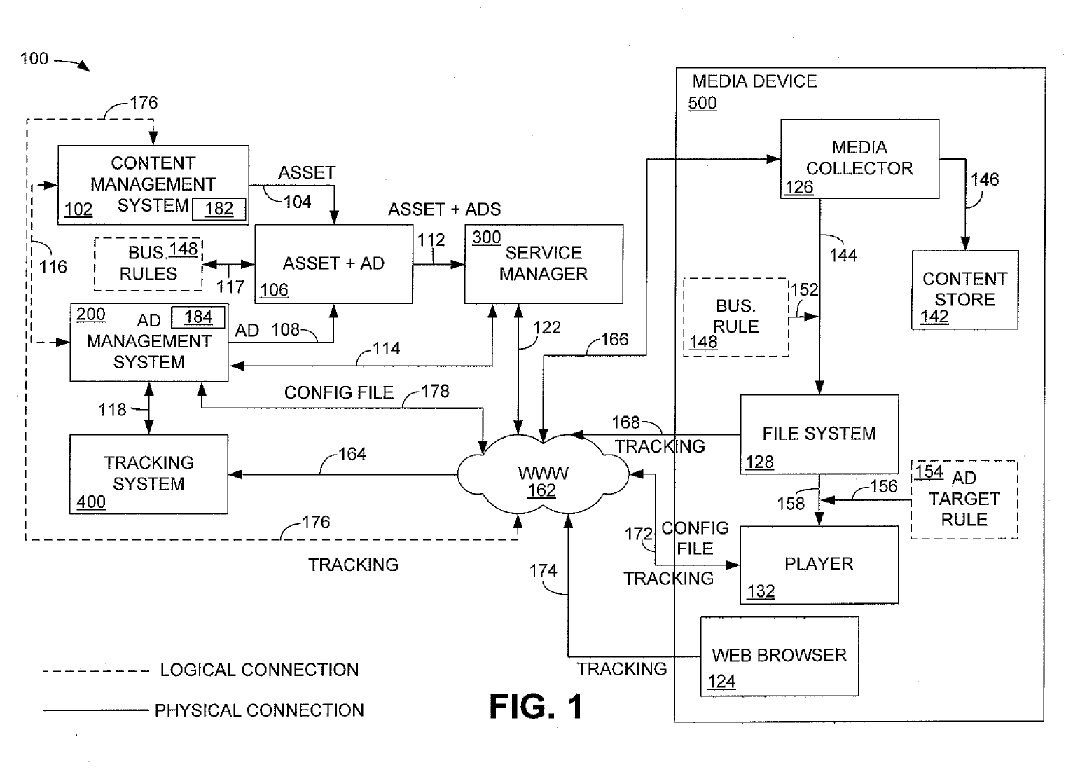

FIG. 1 is a block diagram illustrating an example of an off-line advertisement supported rich media asset system 100. The off-line advertisement supported rich media asset system 100 will also be referred to as the media asset system 100. The media asset system 100 includes a content management system 102 that is logically connected to or otherwise associated with an advertisement management system 200 via connection 116. The term “logical connection” implies that the elements are not necessarily physically connected, but rather, that they have a logical connection or association between them. In this example, the content management system 102 can be connected to the advertisement management system 200 via, for example, a network, such as the World Wide Web, or another network.

The content management system 102 provides content in the form of a media asset, also referred to as a rich media asset. Examples of media assets provided by the content management system include, but are not limited to, video programming, audio programming, games, sports events, interactive programming and features, such as interactive advertisements, etc. An asset 182 is illustrated for simplicity.

The advertisement management system 200 provides advertisements that can be combined with the media assets provided by the content management system 102. An advertisement 184 is illustrated for simplicity. In an embodiment, one or more advertisements provided by the advertisement management system 200 via connection 108 are combined with one or more media assets provided by the content management system 102 via connection 104 by the asset+advertisement module 106. In an embodiment, business rules 148 are used to determine what advertisements to combine with what media asset. The business rules 148 are coupled to or otherwise associated with the asset+advertisement module 106 via connection 117. The business rules 148 are a set of instructions that define the relationship between the media asset and the advertisement. This includes the ad or ads to associate with an asset. The business rules 148 also determine the position in the asset to show the advertisement, the position on the display screen to show the advertisement, which advertisement of a number of possible advertisements to display at a particular location or time in the asset, the time of day to display an asset, etc.

An example of the business rules 148 includes, but is not limited to, the scheduling of a number of advertisement campaigns for an episode of a television program. For example, for each advertisement campaign there can be a video advertisement and a logo image. When the television program is played to a user, there could be one image location and two advertisement breaks. The business rule to play the advertisement-supported television episode can be “insert the logo image in the advertisement image location synchronizing with the video advertisement.” This business rule could insert the logo image at a particular location on the display while the advertisement is playing at a location in the media asset determined by the business rule. Further, the advertisement and the logo image can be displayed separately. The multiple video advertisements can be chosen randomly for an advertisement break, and the displayed image advertisement can be from the same advertisement campaign.

The media asset plus the advertisement or advertisements are provided via connection 112 to the service manager 300. A configuration file defining the media asset and the pool of advertisements is also created by the advertisement management system 200 and supplied to the service manager 300 via connection 114.

The media asset system 100 also includes a tracking system 400, a service manager 300 and a media device 500 connected via a wide area network 162, such as, for example but not limited to, the World Wide Web. The tracking system 400 is also logically connected to or otherwise associated with the advertisement management system 200 via connection 118.

The media device can be, for example, a portable communications device, a portable media player, a personal computer, a “set top box” used for television programming or any other device capable of receiving and playing a media asset. The media device 500 may include a media collector 126, a content store 142, a file system 128, a player 132 and a browser 124. In accordance with an embodiment of the media asset system 100, the media device 500 plays content according to business rules 148 and advertisement target rules 154. The configuration file can be provided to the player 132 via the network 162 and connection 172. In an embodiment, the service manager 300 provides the asset and the advertisements to the media device 500 via connection 122 and via the network 162. Alternatively, the configuration file can be provided to player 132 via a portable removable memory element, along with the asset and the advertisement.

In an alternative embodiment, the media device 500 and the player 132 can be separate devices that can be connected and can synchronize with each other. The media device 500 can be, for example, a personal computer, and the player 132 can be a dedicated player, a cell phone, or another player device. In such an embodiment, the media device 500 can obtain the content and the advertisements, as described herein. The player 132 can synchronize to the media device 500 and the content, advertisements and business rules can be transferred to the player 132, and played as described below.

In an embodiment, a user of the media device 500 can employ the browser 124 to access a website via the network 162. As a nonlimiting example, a user of the media device 500 can access a website to download a media asset from the content management system 102. In accordance with an embodiment of the media asset system 100, a user of the media device 500 can obtain a download of the media asset including one or more advertisements as described above. In this manner, a user of the media device 500 can obtain access to rich media, so long as the user is willing to view advertisements. In such a model, advertising revenue is generated by inserting the advertisements along with the media asset, and allow a revenue stream to be created without charging the end user for the media asset.

In an embodiment, the media asset and the advertisements are received in the media device 500 via connection 166 by the media collector 126. The media collector 126 stores the content in the content store 142 and provides the downloaded content and advertisements to a file system 128. Business rules 148 are applied to the media asset and the advertisements to define, for example, when the advertisements might expire. In this application, an example of a business rule can be that the downloaded content expires in some number of days, after which time the media device 500 is reconnected to the network 162 and the content, including an updated asset and an updated advertisement or advertisements, is again obtained.

In another alternative embodiment, in which the media device is, for example, a computer and the player 132 is a dedicated player, a cell phone, etc., the media device 500 can obtain the content including the asset and the advertisements over a peer-to-peer network and can then transfer the asset and the advertisement to the player. In another alternative embodiment, the media device 500 can obtain the content including the asset and the advertisements from an external portable removable memory element and can then transfer the asset and the advertisement to the player.

In another alternative embodiment, in which the media device is a set top box, the media device 500 may receive and store a number of advertisements that can be played to a viewer at a time determined by a number of factors. The factors that determine when a particular advertisement is displayed to a viewer include, but are not limited to, a viewer preference associated with the set top box, a demographic determined by viewer patterns, a preferred time within the content (e.g., a “climax moment” in the content) etc.

In accordance with an embodiment of the media asset system 100, after the media asset and advertisements are received in the media device 500, the connection between the media device 500 and the network 162 can be terminated. When a user of the media device 500 wishes to view the media asset, the user invokes the player 132. The player 132 receives the media asset from the file system 128 via connection 158. The advertisement target rules 154 are then applied to the media asset and the advertisement. The advertisement target rules define when and where in the media asset the advertisements appear. For example, the player 132 can build a playlist that can be dynamically configured to provide dynamic advertisement rotation into the content so that as the content is being played and viewed by a user of the media device 500, one or more advertisements are inserted into the content in accordance with the advertisement target rules 154. As an example of the advertisement target rules, two sets of video advertisements can be associated with a particular media asset. A first set of video advertisements can be configured to play one time the first time the media asset is played. The second set of video advertisements can be configured to play each subsequent time the media asset is played. When a user starts to play the media asset, the player 132 checks the past playback history for the particular media asset and determines which ad to play based on the configuration. In this manner the delivery of advertisements can be either predefined or dynamically configured at the time the media asset is played so that the user is exposed to as many advertisements as the system dictates.

It is desirable to have a tracking system updated with information relevant to the media asset and the advertisements that a user is viewing or has viewed. The browser 124 can provide tracking information via connection 174 through the network 162 to the tracking system 400 via connection 164. In another embodiment, the file system 128 can provide tracking information via connection 168 to the network 162, and ultimately to the tracking system 400 via connection 164. In yet another embodiment, the player 132 can provide tracking information via connection 172 to the network 162, and ultimately to the tracking system 400 via connection 164.

In an embodiment to be described below, the media device 500 may include additional logic that enables the media device 500 to monitor the advertisement and monitor the user's interaction with the advertisement. This may include actions such as, for example, the number of times the user views the advertisement, which advertisement the user views, or any other interaction that the user has with the advertisement and the media asset. In this example, the user's interaction with the media asset and the advertisement may be stored in the media device 500 and may be transferred to the tracking system 400 when the media device 500 is again connected to the network 162. The tracking system 400 can then be accessed by the advertisement management system 200 and the content management system 102 so that the user's advertisement interaction can be analyzed. Alternatively, the user's interaction with the media asset and the advertisement may be stored in the portable removable memory element and may be transferred to the tracking system via an external network, such as if the portable removable memory element is read by an external reader in a kiosk, or other external location, that can be connected to the tracking system 400 via, for example, the World Wide Web, or another network.

In another embodiment to be described below, the media device 500 may include additional logic that enables the media device 500 to target, sometimes referred to as direct, advertisements. In an embodiment, the media device 500 can be a set top box that can be uniquely identified to the broadcast system on which it is operating and can be associated with individual households, or individual viewers within a household. Such a media device 500 can be associated with individual households, or individual viewers within a household through demographic data, psychographic data, a number of behaviors, including shows watched and, in the case of bundled internet services, web browsing activity. In households with multiple set top boxes, specific behaviors per box can be associated and inferred. For example, it may be straightforward to determine the television the children watch verses the television in a parent's room based on traffic patterns and viewing behaviors. Given this information, the set top box can be “tagged” as belonging to one of “N” targeting groups.

The broadcast stream may include a number of commercial slots. Each commercial slot may further be divided into sub-slots, also referred to as advertisement slots, so that multiple advertisements can be located in each commercial slot. The different advertisements are located in different uniquely identifiable slots or channels. Then, for any given commercial slot, up to “M” advertisements can be broadcast. In an example, one advertisement can be broadcast for each targeting group. This can be achieved in a number of ways, from collective encoding to the use of different “channels” for each advertisement. The set top box can then choose, based on its targeting tag, which of the M advertisements to “tune in” to at the appropriate commercial slot.

In another alternative embodiment, a media device 500 having digital video recording (DVR) capability, can download and store copies of advertisements locally. When a commercial slot comes up in a program, the media device 500 could choose to show one of its locally stored advertisements instead of the one in the broadcast stream. Choosing which advertisement to show can be done in a variety of ways, including, but not limited to, the use of household classification and targeting information, a specific directive from a central service to the specific set top box, or a locally hosted commercial “schedule” or “configuration” which would guide local selection for some period of time, e.g., for a given day, or other time period. The result is advertising targeted to the individual set top box, instead of tied only to the television program.

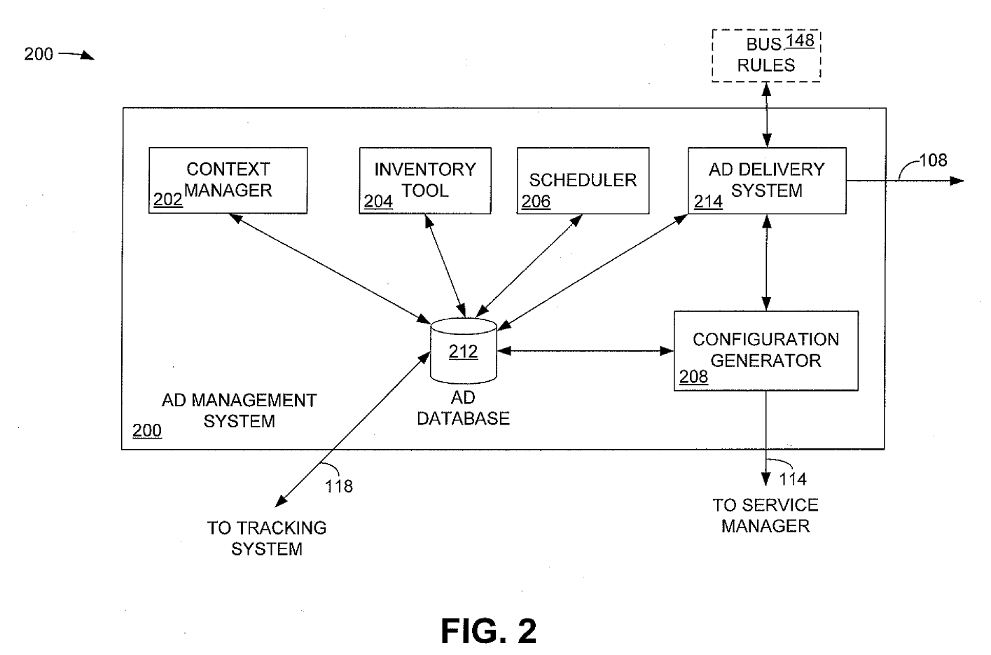

FIG. 2 is a block diagram illustrating an embodiment of the advertisement management system 200 of FIG. 1. The advertisement management system 200 includes a context manager 202, an inventory tool 204, a scheduler 206, an advertisement delivery system 214, a configuration generator 208 and an advertisement database 212. The advertisement delivery system 214 also interfaces with business rules 148 and with the configuration generator 208. The business rules 148 comprise instructions and context to enable the configuration generator 208 to associate the proper advertisement with the proper content.

The business rules 148 determine which advertisement shows on a specific page that is accessed by a user and which is associated with the particular content. When a webpage is requested by a user, the advertisement management system attaches the proper advertisement to the content and provides that content and the advertisement to the service manager 300 (FIG. 1).

The advertisements are stored in the advertisement database 212. The scheduler 206 and the inventory tool 204 are also coupled to the advertisement database 212. When particular content is requested, the advertisement delivery system 214 determines which advertisement to select from the advertisement database 212 to provide to the configuration generator 208. The advertisement delivery system 214 provides an interface to accept advertisement requests. The configuration generator 208 sends a configuration file to the service manager 300 (FIG. 1) via connection 114. The configuration file includes information that allows the service manager 300 to know which advertisements are associated with which content.

The advertisement management system 200 is also coupled to the tracking system 400 via connection 118 to provide advertisement tracking information.

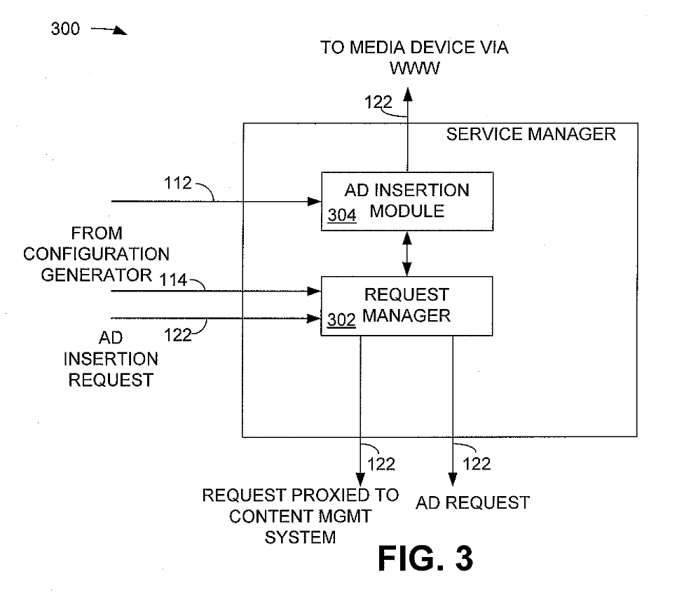

FIG. 3 is a schematic diagram illustrating an embodiment of the service manager 300 of FIG. 1. The service manager 300 includes a request manager 302 and an advertisement insertion module 304. The service manager 300 receives an incoming request via connection 122. The service manager 300 proxies the request to the content management system 102 (FIG. 1) via connections 122 and 176, and acquires the content including the advertisement via connection 112. The service manager 300 also receives the configuration file from the advertisement management system 200 via connection 114. The advertisement insertion module 304 receives the content and the advertisement via connection 112 and provides the content and the advertisement to the media device 500 via connection 122 and the World Wide Web.

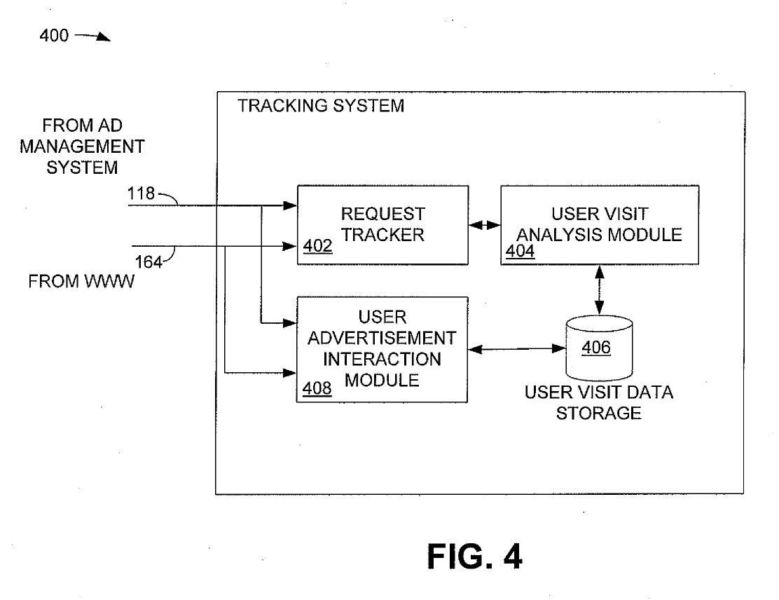

FIG. 4 is a block diagram illustrating an embodiment of the tracking system 400 of FIG. 1. The tracking system 400 includes a request tracker 402, a user visit analysis module 404 and a user advertisement interaction module 408. The user visit analysis module 404 and the user advertisement interaction module 408 are coupled to a user visit data storage element 406. The request tracker 402 receives tracking information from the World Wide Web via connection 164 and from the advertisement management system 200 via connection 118. The tracking information received via the World Wide Web can be generated by the media collector 126, the file system 128, or the browser 124. The user visit analysis module 404 processes and aggregates the user visit information, and stores the information in the user visit data storage element 406. The advertisement interaction module 408 receives another form of tracking information in the form of user advertisement interaction information from the World Wide Web via connection 164 and from the advertisement management system 200 via connection 118. In an embodiment, the user advertisement interaction information may be provided by logic in the media device 500, as will be described below. In an embodiment, the tracking information may be used to determine the association of the primary content and the secondary content. The user advertisement interaction information is used to determine the user's interaction with the advertisement so that trend information can be developed for that particular user.

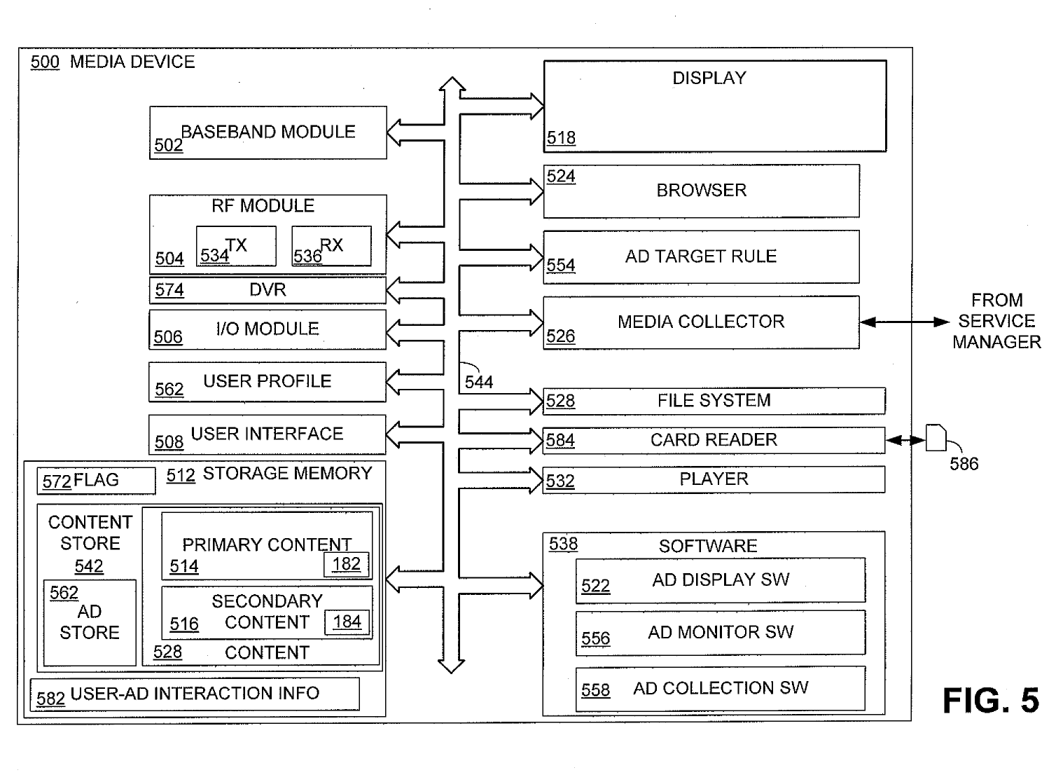

FIG. 5 is a block diagram illustrating a media device in accordance with an embodiment of the system and method for delivering offline advertisement supported digital content. In an embodiment, the media device 500 can be a portable communication device, such as, for example, a portable cellular-type communication device. However, any device capable of downloading, or otherwise obtaining content can be implemented as the media device 500. Only the basic elements of a media device will be illustrated as the operation of such devices is understood by those skilled in the art. The media device 500 includes a baseband module 502, a radio frequency (RF) module 504, an input output (I/O) module 506, a user interface 508, a storage memory 512, a display 518, a browser 524, an advertisement target rule element 554, a media collector 526, a file system 528, a player 532 and software 538 connected via a logical and physical communication bus 544.

In an alternative embodiment, the media device 500 and the player 132 can be separate devices that can be connected and can synchronize with each other. The media device 500 can be, for example, a personal computer, and the player 132 can be a dedicated player, a cell phone, or another player device. In such an embodiment, the media device 500 can obtain the content and the advertisements. The player 132 can synchronize to the media device 500 and the content, advertisements and business rules can be transferred to the player 132, and played as described herein.

The RF module 504 generally may contain a transmitter 534 and a receiver 536, as known in the art. The baseband module 502 and the RF module 504 may also contain analog, digital and mixed signal circuitry and software that allow the media device 500 to transmit and receive voice and data signals, and will not be described in detail as they would be understood by one having ordinary skill in the art. The I/O module 506 includes the interfaces that allow the media device 500 to send, receive and interpret information. Depending on the type of media device implemented, the user interface 508 may include one or more of the following: a microphone, a speaker, a keyboard, a touchpad, a mouse, a trackball, a pointing device, and any other user input and output devices. The storage memory 512 includes the memory used for the normal operation of the media device 500 and also includes a content store 542 having a location at which to store the primary content 514 and a location at which to store secondary content 516. In this example, the primary content 514 may include a media asset 182, such as a television program, or other video programming. In this example, the secondary content 516 represents an advertisement 184 that is associated with the media asset 182 that is delivered to the media device 500 in accordance with the embodiments described herein. The primary content may include a number of different media assets and the secondary content may include a number of different advertisements.

In an embodiment in which the primary content 514 and the secondary content 516 is provided to the media device 500 via a portable removable memory element, the media device 500 includes a card reader 584 coupled to the logical and physical communication bus 544. The card reader 584 can be adapted to receive a portable removable memory element 586. The portable removable memory element 586 can be, for example, a flash memory card or device, such as a secure digital (SD) memory card, a flash memory drive, or any other portable memory element. Such a portable memory device can be inserted, or otherwise associated with the media device so that the media collector 526 can obtain the primary, secondary content, the advertisement target rule or rules, and the business rules either directly or indirectly from the portable removable memory element 586.

The media device 500 also includes a software element 538. The software element 538 includes advertisement display software 522, advertisement monitor software 556 and advertisement collection software 558. In some implementations, and depending on the desired functionality, the media device 500 may contain fewer than all of the software elements described herein. The advertisement display software 522 includes the software that the media device 500 uses to display an advertisement at an appropriate time during playback of a media asset according to one or more rules provided by the advertisement target rule element 554. In an embodiment, the advertisement display software 522 interacts with the media collector 526, the file system 528, the advertisement target rule element 554 and the display 518. The advertisement display software 522 includes logic for determining the location in a particular media asset to include and display an advertisement to a user of the media device 500. The media device 500 also includes a browser 524, which enables a user to access and view content via the World Wide Web.

The advertisement monitor software 556 includes the software that the media device 500 uses to monitor and collect information relating to the user's interaction with the advertisement and the media asset. As non-limiting examples, the advertisement monitor software 556 monitors the number of times that a user views an advertisement, monitors which advertisement from the available advertisements the user views and generally monitors the user's interaction with the advertisement. Other non-limiting examples of monitoring the user's interaction with the advertisement include monitoring the user's interaction if the advertisement includes a poll, advertisement or any interactive content to which the user responds and monitoring a user clicking on the advertisement or interactive content to gain access to the advertiser's web page, interactive content, etc. The user advertisement interaction information is stored in the storage memory 512 as user advertisement interaction information 582. In an embodiment, the user advertisement interaction information 582 can be transferred to the tracking system 400 when the media device 500 is again connected to the network 162. In an alternative embodiment, the user advertisement interaction information 582 can be transferred to the portable removable memory element 586 and delivered to the tracking system 400 when the portable removable memory element 586 is coupled to the tracking system 400 via an external network such as, for example, the World Wide Web, or another network.

In an embodiment, the user advertisement interaction information 582 can be used to construct a user profile 562, which is stored on the media device 500. The user profile 562 can include, for example, user preferences regarding programming, viewing habits, advertisements and which type of advertisements to target to a particular user. In another embodiment, the media device 500 may include user login capability so that a single media device 500 may include multiple user profiles. An example of such an embodiment is the application where the media device 500 is what is referred to as a “set top box” that may be used by multiple viewers.

In an alternative embodiment, the user profile 562 can be transferred to the portable removable memory element 586 and provided to the tracking system 400 when the portable removable memory element 586 is coupled to the tracking system 400 via an external network such as, for example, the World Wide Web, or another network.

In an embodiment, the user profile 562 can be used to customize and prioritize the type of advertisement provided to a particular user, based on their particular user profile 562. For example, if the secondary content includes three advertisements and the user chooses to view one of the three advertisements, this choice can be monitored by the advertisement monitor software 556 and can be stored in the media device 500 as user advertisement interaction information 582. The user advertisement interaction information 582 can be used to construct a user profile 562. The user profile 562 is available to the tracking system 400 and can be used to tailor, prioritize, or otherwise direct subsequent advertisements provided to that user, based on the user's choices.

The advertisement collection software 558 includes software that the media device 500 uses to receive and store advertisements in an embodiment in which the media device 500 receives a plurality of advertisements that can be displayed to a user at a particular time in a broadcast stream. In such an embodiment, the advertisements are stored in the advertisement store 562 in the storage memory 512. The advertisement display software 522 includes logic configured to display a particular advertisement at a particular time in a broadcast, based on factors, such as, for example, the user profile 562. Alternatively, the advertisement collection software 558 includes software that the media device 500 uses to receive and store content, assets and advertisements from the portable removable memory element 586.

In an embodiment, the media device 500 may include additional logic that enables the media device 500 to target, sometimes referred to as direct, advertisements. In an embodiment, the media device 500 is a set top box that can be uniquely identified to the broadcast system on which it is operating and can be associated with individual households, or individual viewers with a household. The media device 500 can be uniquely identified using, for example, a media access control (MAC) address. Other methods of uniquely identifying the media device 500 are possible. Such a media device 500 can be associated through demographic data, psychographic data, a number of behaviors, including shows watched and, in the case of bundled internet services, web browsing activity. In households with multiple set top boxes, specific behaviors per box can be associated and inferred. For example, it may be straightforward to determine the television the children watch verses the television in a parent's room based on traffic patterns and viewing behaviors. Given this information, the set top box can be “tagged” as belonging to one of “N” targeting groups. An example of a tag can be a flag 572 set in the storage memory 512 to identify the targeting group to which this particular set top box belongs. The flag 572 is readable by the advertisement display software 522 to identify the targeting group to which this particular set top box belongs. In an embodiment, the flag 572 may be a single value, indicating which of “N” classes the media device 500 belongs to. Alternatively, the flag 572 may be multi-valued, indicating an order of preference depending on which advertisement “slots” are available or filled. In another embodiment, the flag 572 may be a schedule of flags, by times of day and/or days of week, indicating, for instance, that this media device 500 is used by children during certain times and days of week, by a sports fan at other times, and by other classes at other times. Such a schedule may be arbitrarily complex.

In another alternative embodiment, a media device 500 having digital video recording (DVR) capability 574, can download and store copies of advertisements locally in the ad store 562. When a commercial slot comes up in a program, the advertisement display software 522 causes the player 532 to show one of the locally stored advertisements instead of the advertisement in the broadcast stream. Choosing which advertisement to show can be done in a variety of ways, including, but not limited to, analyzing the user profile 562 to determine viewing preferences, the use of household classification and targeting information, a specific directive from a central service to the specific set top box, a locally hosted commercial “schedule” or “configuration” which would guide local selection for some period of time, e.g., for a given day, or other time period.

The media collector 526 manages the collection and processing of the media on the media device 500. In an embodiment, the media is downloaded over a network. In an alternative embodiment, the media device 500 can be connected to the service manager via a peer-to-peer network and the media collector 526 receives the media over the peer-to-peer network. The media collector 526 interacts with the service manager 300 (FIG. 1) to obtain the configuration file that describes the relationship between the media asset and the advertisement. The media collector 526 parses the configuration and sends requests to the advertisement management system 200 (FIG. 1) to download the advertisements and an advertising schedule. The media collector 526 retrieves the media asset from the content management system 102 (FIG. 1) and stores the media asset 182 in the storage memory 512 as primary content 514. The media asset 182 is integrated into the file system 528 and made available to the player 532.

In an embodiment, the file system 528 protects the media asset (content) from being accessed via an unauthorized application. Only a trusted player can read the digital content from the file system 528. One embodiment of the file system 528 is a digital rights management system (DRM) where the key is held by the player 532 to allow the player 132 to read the digital asset. Another embodiment of the file system 528 includes an encryption system that the player 532 can decrypt the content to show to the user.

The player 532 is the user's interface to view the digital content. The player 532 also understands the advertising configuration so it will play the asset with the appropriate advertisement in the part of the content where showing the advertisement is appropriate. The player 532 can also combine advertising content with the asset content at the scheduled time so that the content can be synchronized to the media device 500.

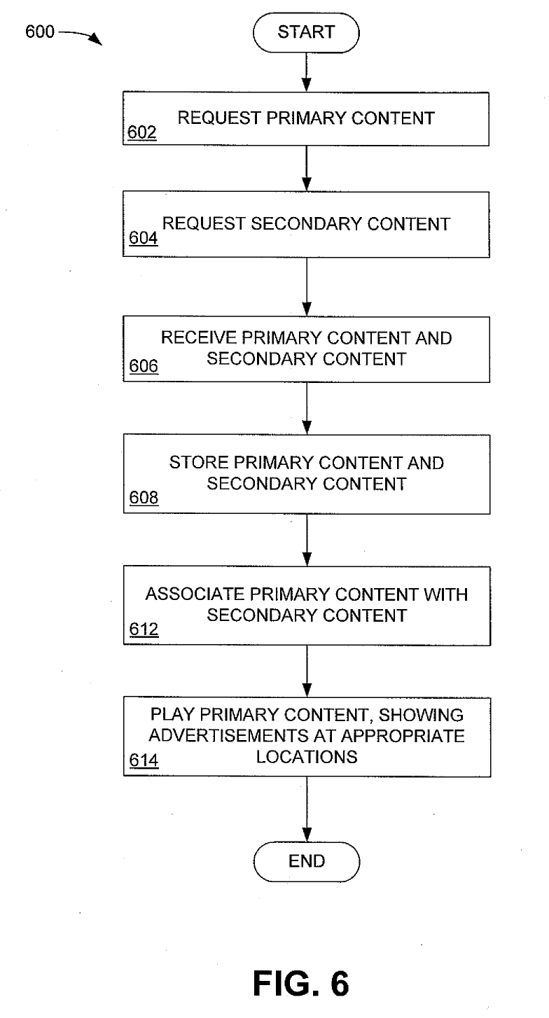

FIG. 6 is a flow chart describing the operation of an embodiment of the media device 500 of FIG. 5. In block 602, the media device 500 requests primary content from the service manager 300 in the form of a rich media asset 182. In an embodiment, the service manager 300 proxies this request to the content management system 102 as described above. Alternatively, the rich media asset 182 may be provided to the media device 500 via the portable removable memory element 586. In block 604, the media device 500 requests secondary content, in the form of an advertisement, from the service manager 300. Alternatively, the secondary content may be provided to the media device 500 via the portable removable memory element 586. In an embodiment, the service manager 300 sends an advertisement request to the advertisement management system 200. In block 606, the asset and the advertisement are delivered to the service manager at 300 and are received as primary content and secondary content by the media device 500. In an alternative embodiment, the advertisement management system 102 (FIG. 1) associates the secondary content with the primary content and provides the asset and the advertisement to the media device 500.

In block 608, the media device 500 stores the primary content 514 and the secondary content 516 in the storage memory 512. In block 612, the file system 528, the advertisement target rule element 554 and the advertisement display software 522 associate the primary content 514 (the media asset 182) with the secondary content 516 (the advertisement 184). In an embodiment, the advertisement 184 is associated with the media asset 182. In block 614, the player 532 plays the primary content (the media asset) showing the secondary content (the advertisement) at the appropriate location.

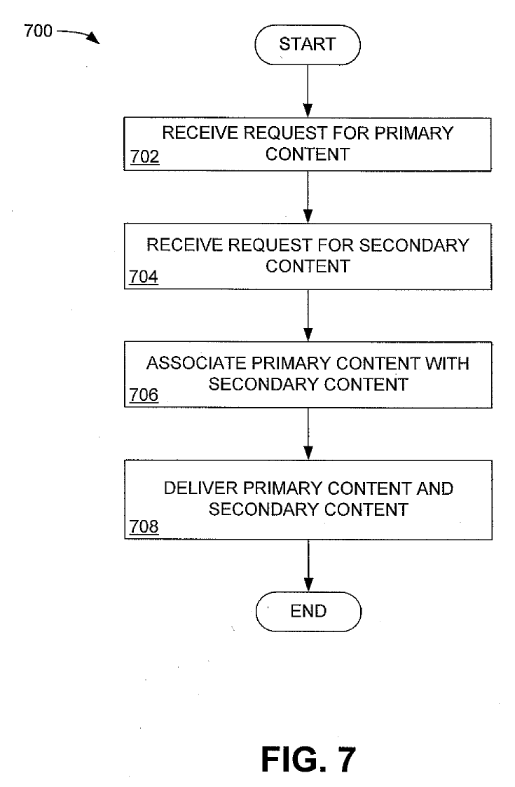

FIG. 7 is a flowchart describing the operation of an embodiment of the content management system 102 and the advertisement management system 200 of FIG. 1. In block 702, the content management system 102 receives a request for primary content (the media asset 182). In block 704, the advertisement management system 200 receives a request for secondary content (the advertisement 184). In block 706, the asset and the advertisement are associated together as an asset and advertisement 106 according to the business rules 148. In block 708, the media asset and the advertisement are delivered to the service manager 300.

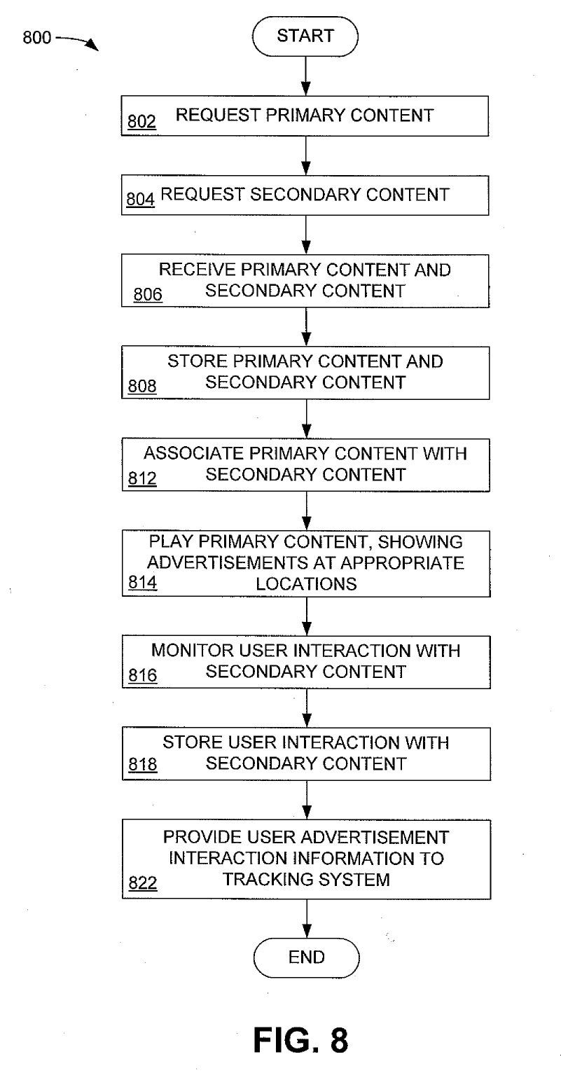

FIG. 8 is a flow chart describing the operation of an alternative embodiment of the media device 500 of FIG. 5. In block 802, the media device 500 requests primary content from the service manager 300 in the form of a rich media asset 182. In an embodiment, the service manager 300 proxies this request to the content management system 102 as described above. In block 804, the media device 500 requests secondary content, in the form of an advertisement, from the service manager 300. In an embodiment, the service manager 300 sends an advertisement request to the advertisement management system 200. In block 806, the asset and the advertisement are delivered to the service manager at 300 and are received as primary content and secondary content by the media device 500. In an alternative embodiment, the advertisement management system 102 (FIG. 1) associates the secondary content with the primary content and provides the asset and the advertisement to the media device 500 without the media device 500 making a request.

In block 808, the media device 500 stores the primary content 514 and the secondary content 516 in the storage memory 512. In block 812, the file system 528, the advertisement target rule element 554 and the advertisement display software 522 associate the primary content 514 (the media asset 182) with the secondary content 516 (the advertisement 184). In an embodiment the advertisement 184 is associated with the media asset 182. In block 814, the player 532 plays the primary content (the media asset) showing the secondary content (the advertisement) at appropriate location or locations.

In block 816, the advertisement monitor software 556 monitors user interaction with the secondary content 516. In block 818, the user's interaction with the secondary content is stored as user advertisement interaction information 582 in the storage memory 512. In block 822, the user advertisement interaction information 582 is provided to the tracking system 400 when the media device 500 is again connected to the network 162.

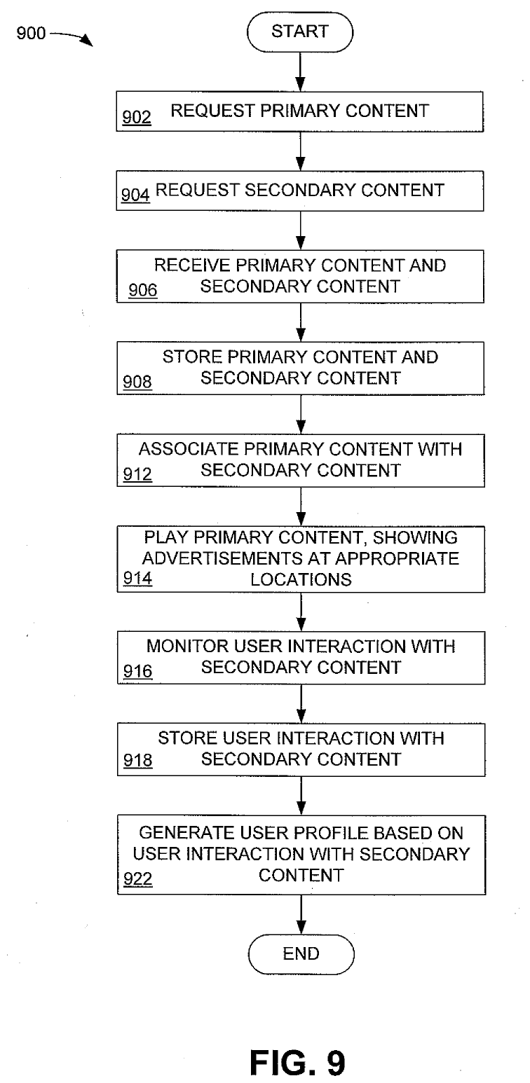

FIG. 9 is a flow chart describing the operation of another alternative embodiment of the media device 500 of FIG. 5. In block 902, the media device 500 requests primary content from the service manager 300 in the form of a rich media asset 182. In an embodiment, the service manager 300 proxies this request to the content management system 102 as described above. In block 904, the media device 500 requests secondary content, in the form of an advertisement, from the service manager 300. In an embodiment, the service manager 300 sends an advertisement request to the advertisement management system 200. In block 906, the asset and the advertisement are delivered to the service manager at 300 and are received as primary content and secondary content by the media device 500. In an alternative embodiment, the advertisement management system 102 (FIG. 1) associates the secondary content with the primary content and provides the asset and the advertisement to the media device 500 without the media device 500 making a request.

In block 908, the media device 500 stores the primary content 514 and the secondary content 516 in the storage memory 512. In block 912, the file system 528, the advertisement target rule element 554 and the advertisement display software 522 associate the primary content 514 (the media asset 182) with the secondary content 516 (the advertisement 184). In an embodiment, the advertisement 184 is associated with the media asset 182. In block 914, the player 532 plays the primary content (the media asset) showing the secondary content (the advertisement) at the appropriate location.

In block 916, the advertisement monitor software 556 monitors user interaction with the secondary content 516. In block 918, the user's interaction with the secondary content is stored as user advertisement interaction information 582 in the storage memory 512. In block 922, the user advertisement interaction information 582 is used to generate a user profile 562. The user profile can be used to tailor subsequent advertisements to the user based on past user-advertisement interaction.

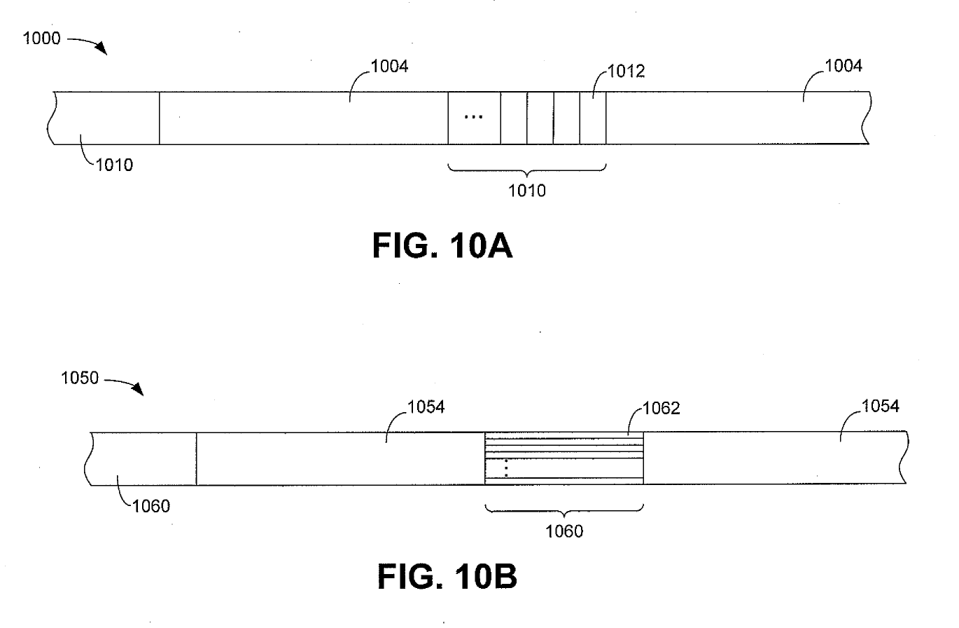

FIG. 10A is a schematic diagram illustrating an embodiment of a simplified program stream 1000. The program stream 1000, which in a non-limiting example can be a broadcast stream, includes a content portion 1004 followed by a commercial slot 1010. This structure is continuously repeated. In an embodiment, the commercial slot 1010 is divided into a plurality of time periods 1012, each time period comprising an advertisement or an advertisement indicator. A method of creating the time periods 1012 is sometimes referred to as time division multiplexing (TDM), so that each advertisement, or advertisement indicator, is allotted a predefined unique period of time.

FIG. 10B is a schematic diagram illustrating an alternative embodiment of a simplified program stream 1050. The program stream 1050, which in a non-limiting example can be a broadcast stream, includes a content portion 1054 followed by a commercial slot 1060. This structure is continuously repeated. In an embodiment, the commercial slot 1060 is divided into a plurality of frequency channels 1062, each frequency channel comprising an advertisement or an advertisement indicator. The method of creating the frequency channels 1062 is sometimes referred to as frequency division multiplexing (FDM), so that each advertisement, or advertisement indicator, is allotted a predefined unique frequency. Other methods and techniques for assigning each of the advertisements or advertisement indicators a uniquely identifiable location are possible.

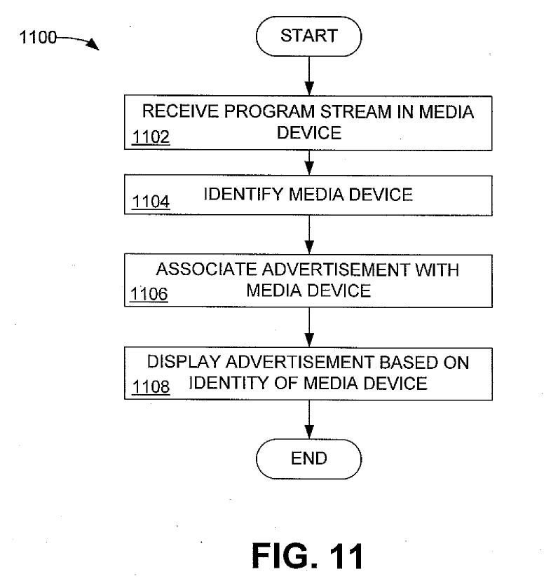

FIG. 11 is a flow chart describing the operation of another alternative embodiment of the media device 500 of FIG. 5. In block 1102, a program stream is received in a media device 500. The program stream comprises a plurality of commercial slots, each commercial slot comprising a plurality of advertisements. In block 1104, the identity of the media device is determined. For example, the advertisement display software 522 can determine the value of the flag 572. The value of the flag 572 can identify the targeting group to which the media device 500 belongs. In block 1106, a selected one of the advertisements is associated with the media device 500 based on the targeting identity of the media device 500. In block 1108, the selected one of the plurality of advertisements is displayed to a user.

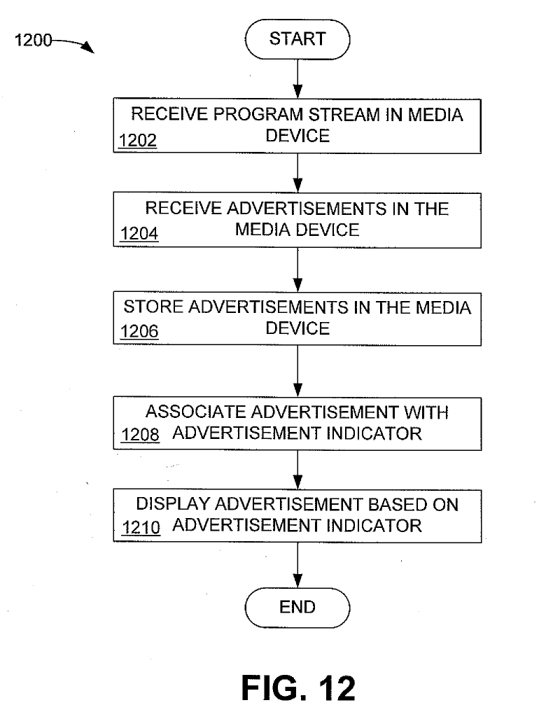

FIG. 12 is a flow chart describing the operation of another alternative embodiment of the media device 500 of FIG. 5. In block 1202, a program stream is received in a media device 500. The program stream comprises a plurality of commercial slots, each commercial slot comprising a plurality of advertisement indicators. In block 1204, a plurality of advertisements are received in the media device. At least a portion of the advertisements correspond to the plurality of advertisement indicators. In block 1206, the advertisements are stored in the advertisement store 562 in the media device 500. In block 1208, a selected one of the plurality of advertisements is associated with a selected one of the plurality of advertisement indicators. In block 1210, the selected one of the plurality of advertisements is displayed.

While various embodiments of the invention have been described, it will be apparent to those of ordinary skill in the art that many more embodiments and implementations are possible that are within the scope of the invention. The system and method for delivering offline advertisement supported digital content is not limited to a specific type of additional asset or advertisement.

What is claimed is:

1. A system for receiving advertisement supported content in a media device, comprising:
a media collector for receiving primary content and secondary content in a media device, the primary content comprising a media asset and the secondary content comprising an advertisement;
a file system for organizing the primary content and the secondary content; and
a player for playing the primary content and inserting the secondary content into the primary content at a time determined by the file system.

2. The system of claim 1, further comprising at least one business rule configured to determine the secondary content that is associated with the primary content.

3. The system of claim 1, further comprising at least one advertising target rule configured to determine when the secondary content is played in the primary content.

4. The system of claim 1, further comprising a service manager configured to receive a configuration file describing the primary content and the secondary content.

5. The system of claim 1, further comprising a tracking system configured to analyze the primary content and the secondary content provided to a user of the system.

6. The system of claim 2, in which the at least one business rule defines which secondary content is associated with which primary content.

7. The system of claim 3, in which the at least one advertising target rule defines a manner in which the secondary content is displayed within the primary content.

8. The system of claim 1, further comprising logic for monitoring and storing user interaction information relating to a user's interaction with the secondary content.

9. The system of claim 8, wherein the user interaction information is provided to a tracking system.

10. The system of claim 9, further comprising a user profile comprising the user interaction information.

11. The system of claim 10, wherein the user profile determines the secondary content.

12. The system of claim 1, wherein the primary content and the secondary content are provided to the player via an external memory element.

13. A method for receiving advertisement supported content in a media device, comprising:
receiving primary content and secondary content, the primary content comprising a media asset and the secondary content comprising an advertisement;
organizing the primary content and the secondary content; and
playing the primary content and inserting the secondary content into the primary content at a predetermined time.

14. The method of claim 13, further comprising implementing at least one business rule configured to determine the secondary content that is associated with the primary content.

15. The method of claim 13, further comprising implementing at least one advertising target rule configured to determine when the secondary content is played in the primary content.

16. The method of claim 13, further comprising providing a configuration file describing the primary content and the secondary content.

17. The method of claim 13, further comprising analyzing the primary content and the secondary content provided to a user of the system.

18. The method of claim 14, in which the at least one business rule defines which secondary content is associated with which primary content.

19. The method of claim 15, in which the at least one advertising target rule defines a manner in which the secondary content is displayed within the primary content.

20. The method of claim 13, further comprising monitoring and storing user interaction information relating to a user's interaction with the secondary content.

21. The method of claim 20, farther comprising providing the user interaction information to a tracking system.

22. The method of claim 21, further comprising generating a user profile based on the user interaction information.

23. The method of claim 22, further comprising using the user profile to determine the secondary content.

24. A method for assembling and delivering advertisement supported content, comprising:
receiving a request for primary content;
receiving a request for secondary content;
associating the primary content and the secondary content according to at least one predetermined rule; and
delivering the primary content and the secondary content to a user.

25. The method of claim 24, in which associating the primary content and the secondary content according to at least one predetermined rule further comprises implementing at least one business rule configured to determine the secondary content that is associated with the primary content.

26. The method of claim 24, further comprising providing a configuration file having information relating to the primary content and the secondary content.

27. The method of claim 26, further comprising providing the primary content and the secondary content and the configuration file to a service manager.

28. The method of claim 24, further comprising generating tracking information to analyze the primary content and the secondary content provided to a user.

29. The method of claim 28, in which the tracking information is provided to control the association of the primary content and the secondary content.

30. The method of claim 24, further comprising monitoring and storing user interaction information relating to the user's interaction with the secondary content.

31. The method of claim 30, further comprising providing the user interaction information to a tracking system.

32. The method of claim 31, further comprising generating a user profile based on the user interaction information.

33. The method of claim 32, further comprising using the user profile to determine the secondary content.

34. A system for receiving advertisement supported content in a media device, comprising:
a media collector for receiving primary content and secondary content in a media device, the primary content comprising a media asset and the secondary content comprising an advertisement;
a file system for organizing the primary content and the secondary content;
a player for playing the primary content and inserting the secondary content into the primary content at a time determined by the file system; and
a software element configured to monitor a user's interaction with the secondary content.

35. The system of claim 34, further comprising a memory element for storing information relating to the user's interaction with the secondary content.

36. The system of claim 35, further comprising a user profile based on the information relating to the user's interaction with the secondary content.

37. The system of claim 36, in which the user profile is provided to a tracking system.

38. The system of claim 36, in which the user profile is used to determine the secondary content.

39. A method for receiving advertisement supported content in a media device, comprising:
receiving primary content and secondary content, the primary content comprising a media asset and the secondary content comprising an advertisement;
organizing the primary content and the secondary content;
playing the primary content and inserting the secondary content into the primary content at a predetermined time; and
monitoring a user's interaction with the secondary content.

40. The method of claim 39, further comprising storing information relating to the user's interaction with the secondary content.

41. The method of claim 40, further comprising generating a user profile based on the information relating to the user's interaction with the secondary content.

42. The method of claim 41, further comprising providing the user profile to a tracking system.

43. The method of claim 41, further comprising using the user profile to determine the secondary content.

44. A method for assembling and delivering advertisement supported content comprising:
receiving a request for primary content;
receiving a request for secondary content;
associating the primary content and the secondary content according to at least one predetermined rule;
delivering the primary content and the secondary content to a user; and
monitoring a user's interaction with the secondary content.

45. A system for targeting advertisements, comprising:
a media device configured to receive a program stream, the program stream comprising a plurality of commercial slots, each commercial slot comprising a plurality of advertisements;
a device indicator configured to identify the media device; and
a player for displaying a selected one of the plurality of advertisements based on the indicator.

46. The system of claim 45, in which each of the plurality of advertisements are uniquely identified using a separate time period.

47. The system of claim 45, in which each of the plurality of advertisements are uniquely identified using a separate frequency.

48. The system of claim 45, in which the device indicator is a flag set in a memory.

49. The system of claim 45, in which the indicator defines an advertisement targeting group to which the media device belongs.

50. The system of claim 49, in which a selected one of the plurality of advertisements corresponds to the advertisement targeting group.

51. A method for targeting advertisements, comprising:
receiving a program stream in a media device, the program stream comprising a plurality of commercial slots, each commercial slot comprising a plurality of advertisements;
identifying the media device;
associating a selected one of the plurality of advertisements based on an identity of the media device; and
displaying the selected one of the plurality of advertisements.

52. The method of claim 51, further comprising uniquely identifying each of the plurality of advertisements using a separate time period.

53. The method of claim 51, further comprising uniquely identifying each of the plurality of advertisements using a separate frequency.

54. The method of claim 51, further comprising setting a memory flag to identify the media device.

55. The method of claim 51, further comprising assigning the media device to an advertisement targeting group.

56. The method of claim 55, further comprising associating a selected one of the plurality of advertisements with the advertisement targeting group.

57. A system for targeting advertisements, comprising:
a media device configured to receive a program stream, the program stream comprising a plurality of commercial slots, each commercial slot comprising a plurality of advertisement indicators;
a device indicator configured to identify the media device;
a plurality of advertisements stored on the media device, at least a portion of the advertisements corresponding to the plurality of advertisement indicators; and
a player for displaying a selected one of the plurality of advertisements based on the advertisement indicator and the device indicator.

58. The system of claim 57, in which each of the plurality of advertisement indicators are uniquely identified using a separate time period.

59. The system of claim 57, in which each of the plurality of advertisement indicators are uniquely identified using a separate frequency.

60. The system of claim 57, in which the device indicator is a flag set in a memory.

61. The system of claim 57, in which the device indicator defines an advertisement targeting group to which the media device belongs.

62. The system of claim 61, in which a selected one of the plurality of advertisements corresponds to the advertisement targeting group.

63. A method for targeting advertisements, comprising:
receiving a program stream in a media device, the program stream comprising a plurality of commercial slots, each commercial slot comprising a plurality of advertisement indicators;
identifying the media device;
receiving a plurality of advertisements in the media device, at least a portion of the advertisements corresponding to the plurality of advertisement indicators;
storing the plurality of advertisements in the media device;
associating a selected one of the plurality of advertisements with a selected one of the plurality of advertisement indicators; and
displaying the selected one of the plurality of advertisements.

64. The method of claim 63, further comprising uniquely identifying each of the plurality of advertisement indicators using a separate time period.

65. The method of claim 63, further comprising uniquely identifying each of the plurality of advertisement indicators using a separate frequency.

66. The method of claim 63, further comprising setting a memory flag to identify the media device.

67. The method of claim 63, further comprising assigning the media device to an advertisement targeting group.

68. The method of claim 67, further comprising associating a selected one of the plurality of advertisements with the advertisement targeting group.
